(19) United States
(12) Patent Application Publication
(10) Pub. No.: US 2021/0240284 A1
(43) Pub. Date: Aug. 5, 2021

(54) INPUT CONTROL DEVICE AND INPUT CONTROL METHOD

(71) Applicant: KYOCERA Document Solutions Inc., Osaka (JP)

(72) Inventor: Michiko TASHIRO, Osaka-shi (JP)

(73) Assignee: KYOCERA Document Solutions Inc., Osaka (JP)

(21) Appl. No.: 17/059,373

(22) PCT Filed: Mar. 29, 2019
(86) PCT No.: PCT/JP2019/014218

§ 371 Date: Nov. 27, 2020

(30) Foreign Application Priority Data
May 29, 2018 (JP) 2018-102365

(51) Int. Cl. G06F 3/023; G06F 3/0488; G06F 3/0489

(52) U.S. Cl. CPC G06F 3/0233; G06F 3/04895; G06F 3/04886

(57) ABSTRACT

A smartphone (100) includes a touch panel (1) and a controller (2). The controller (2) includes a receiving section (201), a first determining section (203) and a display controller (205). The receiving section (201) receives input of a character string. The first determining section (203) determines whether or not the character string includes a specific character. The display controller (205) displays that the specific character is included based on a result of determination by the first determining section (203). The character string indicates a plurality of arranged characters. The specific character indicates a character which is frequently input erroneously.

### TECHNICAL FIELD

The present invention relates to an input control device and an input control method.

### BACKGROUND ART

An input receiving device according to Patent Literature 1 stores a decryption program. The decryption program stores symbols composing a password in association with symbols that may be erroneously entered as the symbols composing the password. In receiving and decrypting the password, the decryption program corrects erroneously entered symbols and decrypts the symbols into correct password information.

### CITATION LIST

### Patent Literature

### [Patent Literature 1]

Patent Literature 1: Japanese Patent Application Laid-Open Publication No. 2003-150552

### SUMMARY OF INVENTION

### Technical Problem

However, in the input receiving device according to Patent Literature 1, a user may not notice erroneous input because the password is corrected without notifying the user. As a result, the user may repeat the same error.

The present invention takes the above problem into account, and an object thereof is to provide an input control device and an input control method in which a user can easily recognize erroneous input.

### Solution to Problem

An input control device according to the present invention includes a receiving section, a first determining section, and a display controller. The receiving section receives input of a symbol string. The first determining section determines whether or not the symbol string includes a specific symbol. The display controller displays that the specific symbol is included based on a result of determination by the first determining section. The symbol string indicates a plurality of arranged symbols. The specific symbol represents a symbol which is frequently input erroneously.

An input control method according to the present invention is for implementation in an input control device. The input control method includes receiving, primarily determining, and display controlling. In the receiving, input of a symbol string is received. In the primarily determining, whether or not the symbol string includes a specific symbol is determined. In the display controlling, that the specific symbol is included is displayed based on a result of the primarily determining. The symbol string indicates a plurality of arranged symbols. The specific symbol indicates a symbol which is frequently input erroneously.

### Advantageous Effects of Invention

According to the input control device and the input control method of the present invention, a user can easily recognize erroneous input.

### BRIEF DESCRIPTION OF DRAWINGS

FIG. 1 is a diagram illustrating an example of a configuration of a tablet terminal device according to an embodiment of the present invention.

FIG. 2 is a screen diagram illustrating an example of a first screen displayed on a touch panel.

FIG. 3 is a diagram illustrating an example of a configuration of a controller according to an embodiment of the present invention.

FIG. 4 is a screen diagram illustrating an example of a second screen displayed on the touch panel.

FIG. 5 is a flowchart illustrating an example of a process performed by the controller.

### DESCRIPTION OF EMBODIMENTS

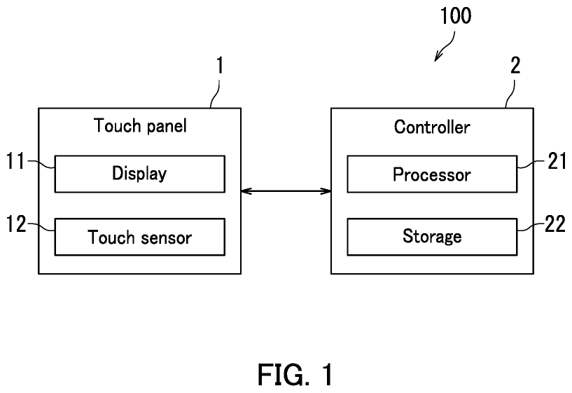

The following describes an embodiment of the present invention with reference to the accompanying drawings (FIGS. 1 to 5). Note that elements that are the same or equivalent are labeled with the same reference signs in the drawings and description thereof is not repeated.

First, the configuration of a smartphone 100 according to the embodiment of the present invention is described with reference to FIG. 1. FIG. 1 illustrates the configuration of the smartphone 100. As illustrated in FIG. 1, the smartphone 100 includes a touch panel 1 and a controller 2. The touch panel 1 displays an image and receives operation from a user. The controller 2 controls the operation of the touch panel 1. The smartphone 100 corresponds to an example of an “input control device”.

The touch panel 1 includes a display 11 and a touch sensor 12. The display 11 includes for example a liquid-crystal display (LCD) and displays various images. The touch sensor 12 receives operation from a user. The touch sensor 12 is arranged over the display surface of the display 11, for example. The touch panel 1 is formed in a rectangular shape.

The controller 2 includes a processor 21 and storage 22. The processor 21 includes a central processing unit (CPU), for example. The storage 22 includes memory such as semiconductor memory and may also include a hard disk drive (HDD). The storage 22 stores a control program.

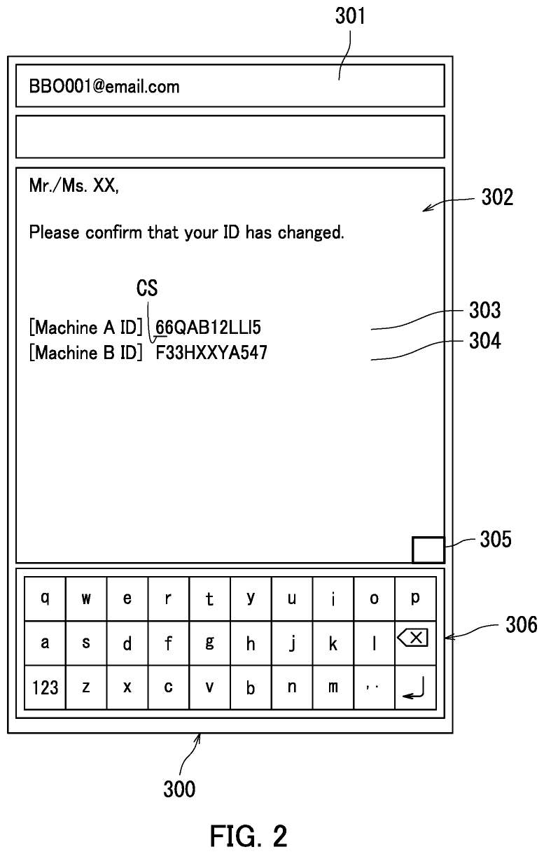

Next, a first screen 300 displayed on the touch panel 1 is described with reference to FIGS. 1 and 2. FIG. 2 is a screen diagram illustrating an example of the first screen 300 displayed on the touch panel 1. As illustrated in FIG. 2, a destination display section 301, a text display section 302, a check input section 305, a character input section 306, and a cursor CS are displayed in the first screen 300. The first screen 300 is displayed on the touch panel 1 by the controller 2.

Symbol strings are displayed in the destination display section 301 and the text display section 302. A “symbol string” indicates a plurality of arranged symbols. “Symbols” include characters, marks, and symbols. “Characters” include Japanese hiragana, Japanese katakana, Japanese or Chinese kanji, alphabet, and numbers. The embodiment of the present invention describes a case in which a “symbol string” is a character string. Specifically, the embodiment of the present invention describes a case in which a “symbol string” is a character string CP of alphanumeric characters.

The destination display section 301 displays the destination of an e-mail. That is, the destination display section 301 displays an e-mail address indicating the destination of an e-mail. “BB0001@email.com” for example is displayed as the e-mail address in the destination display section 301.

The text display section 302 displays the text of an e-mail. “Mr./Ms. XX, Please confirm that your ID has changed.” for example is displayed as the text of an e-mail in the text display section 302. The text display section 302 includes a first display section 303 and a second display section 304.

The first display section 303 displays an identification (ID) of a device A. The device A is a printer, for example. “[Machine A ID] 66QAB12LL15” for example is displayed in the first display section 303.

The second display section 304 displays an ID of a device B. The device B differs from the device A. The device B is a printer, for example. “[Machine B ID] F33HXXYA547” for example is displayed in the second display section 304.

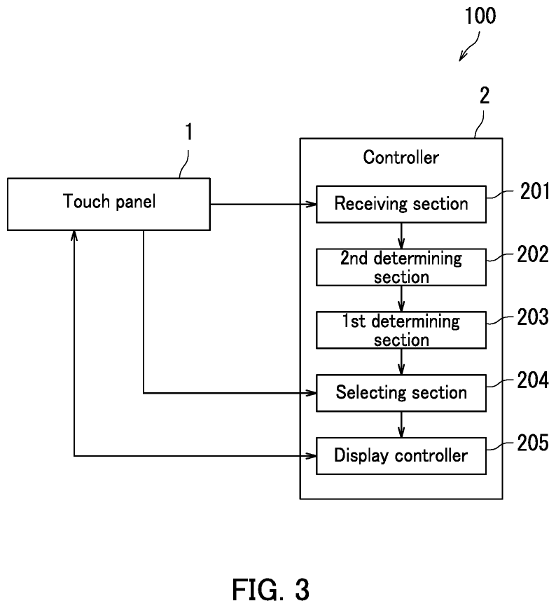

The check input section 305 is used when the user selects whether or not to highlight a specific character CA. Specifically, a check mark is displayed in the check input section 305 by the user touching the check input section 305. In this case, the controller 2 highlights a specific character CA. When a check mark is not displayed in the check input section 305, the controller 2 does not highlight a specific character CA. Items related to “highlighting a specific character CA” are described later in detail with reference to FIG. 3.

The character input section 306 is touched by the user when character strings CP are input to the destination display section 301 and the text display section 302.

The cursor CS indicates a position in which the user can input a character C. The position of the cursor CS can be changed by the user touching the character input section 306. The position of the cursor CS can also be changed by the user touching the destination display section 301 and the text display section 302.

Next, the configuration of the controller 2 according to the embodiment of the present invention is described with reference to FIGS. 1 to 3. FIG. 3 is a diagram illustrating an example of the configuration of the controller 2. As illustrated in FIG. 3, the controller 2 includes a receiving section 201, a second determining section 202, a first determining section 203, a selecting section 204, and a display controller 205. Specifically, the processor 21 of the controller 2 functions as a receiving section 201, a second determining section 202, a first determining section 203, a selecting section 204, and a display controller 205 by executing the control program. The control program is an input control program, for example.

The receiving section 201 receives input of a character string CP. Specifically, the receiving section 201 receives input of a character string CP from the touch panel 1.

The second determining section 202 determines whether or not the character string CP received by the receiving section 201 includes an important character string CPA. An important character string CPA means a character string CP which is important to the user. In the embodiment of the present invention, an important character string CPA means a character string CP which is important to a user receiving the e-mail. Specifically, important character strings CPA include an e-mail address, a home page (HP) address, an ID, a personal identification number (PIN) code, a password, a telephone number, and a fax number.

The first determining section 203 determines whether or not a character string CP includes a specific character CA. Specifically, the first determining section 203 determines whether or not an important character string CPA includes a specific character CA. A specific character CA indicates a character C which is frequently input erroneously. A character C is an alphanumeric character in the embodiment of the present invention. Specifically, specific characters CA include the number “0”, the capital letter “0”, the number “1”, the number “7”, the lowercase letter “l”, the capital letter “I”, the number “6”, the lowercase letter “b”, the number “8”, the capital letter “B”, the number “9”, and the lowercase letter “q”.

The selecting section 204 selects whether or not to display that a specific character CA is included. Specifically, that a specific character CA is included is displayed when a check mark is displayed in the check input section 305 illustrated in FIG. 2. When a check mark is not displayed in the check input section 305, that a specific character CA is included is not displayed.

The display controller 205 displays that a specific character CA is included based on a result of determination by the first determining section 203. Specifically, the display controller 205 highlights the specific character CA. More specifically, the display controller 205 performs at least one of a process to display the specific character CA in bold lettering, a process to attach an underline to the specific character CA, and a process to display the specific character CA in a specific color. In the embodiment of the present invention, the display controller 205 performs a process to display the specific character CA in bold lettering.

In the embodiment of the present invention as described above with reference to FIGS. 1 to 3, the display controller 205 displays that a character string CP includes a specific character CA. A specific character CA indicates a character C which is frequently input erroneously. Accordingly, the user can easily see whether or not an input character C is actually input erroneously. As a result, the user can easily see erroneous input.

The second determining section 202 also determines whether or not a character string CP includes an important character string CPA. The first determining section 203 determines whether or not an important character string CPA includes a specific character CA. The display controller 205 displays that there is an important character string CPA, and that a character C (specific character CA) is included which is frequently input erroneously. Accordingly, the user can easily recognize erroneous input in an important character string CPA.

The display controller 205 also highlights the specific character CA. Accordingly, the user can more easily recognize erroneous input.

Note that in the embodiment of the present invention, the display controller 205 displays that a specific character CA is included in an important character string CPA, but the present invention is not limited as such. The display controller 205 need only display that a specific character CA is included. That is, the first determining section 203 may determine whether or not a specific character CA is included in not only an important character string CPA but in all character strings CP, and the display controller 205 may display that a specific character CA is included based on the result of determination by the first determining section 203. In this case, the user can recognize erroneous input in all character strings CP.

Also in the embodiment of the present invention, the display controller 205 highlights the specific character CA, but the present invention is not limited as such. The display controller 205 need only display that a specific character CA is included. For example, the display controller 205 may display in a pop-up that a specific character CA is included. Specifically, the display controller 205 may display the message: “The input number ‘0’ is a character which is frequently input erroneously as the capital letter ‘0’.” in a pop-up on the touch panel 1. Accordingly, the user can be more specifically alerted according to the content of a pop-up display.

Also in the embodiment of the present invention, the display controller 205 performs a process to display a specific character CA in bold lettering, but the present invention is not limited as such. The display controller 205 need only highlight the specific character CA. That is, the display controller 205 need only perform for example at least one of a process to display the specific character CA in bold lettering, a process to assign an underline to the specific character CA, and a process to display the specific character CA in a specific color. For example, the display controller 205 may perform a process to display the specific character CA in red.

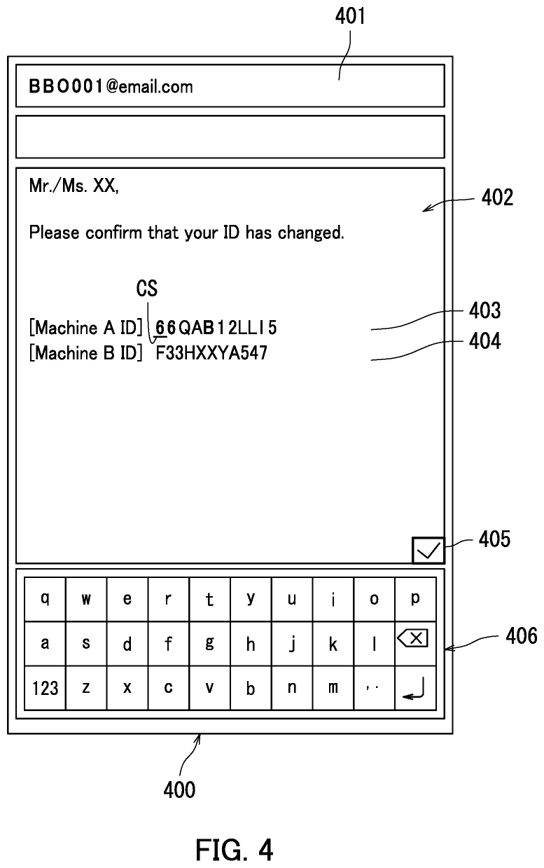

Next, a process performed by the controller 2 is described with reference to FIGS. 1 to 4. FIG. 4 is a screen diagram illustrating an example of a second screen 400 displayed by the touch panel 1. The second screen 400 is a screen displayed on the touch panel 1 as a result of the display controller 205 performing a process to display specific characters CA in bold lettering in the destination display section 301, the first display section 303, and the second display section 304 of the first screen 300 illustrated in FIG. 2. As illustrated in FIG. 4, a destination display section 401, a text display section 402, a check input section 405, a character input section 406, and the cursor CS are displayed in the second screen 400.

The destination display section 401 displays the destination of an e-mail. Specifically, “BB000@email.com” for example is displayed as an e-mail address. The e-mail address is determined to be an important character string CPA by the second determining section 202. Furthermore, the capital letter “B”, the capital letter “0”, the number “0”, and the number “1” included in the e-mail address are determined to be specific characters CA by the first determining section 203. The display controller 205 displays the specific characters CA included in the e-mail address in bold lettering. The display controller 205 also displays the specific characters CA included in the e-mail address with widened character intervals before and after the specific characters C.

The text display section 402 displays the text of an e-mail. The text display section 402 includes a first display section 403 and a second display section 404.

The first display section 403 displays the ID of the device A. “[Machine A ID] 66QAB12LL15” for example is displayed in the first display section 403. The second determining section 202 determines the ID of the device A to be an important character string CPA. Furthermore, the first determining section 203 determines the number “6”, the capital letter “B”, the number “1”, and the lowercase letter “l” included in the ID of the device A to be specific characters CA. The display controller 205 displays the specific characters CA included in the ID of the device A in bold lettering. Additionally, the display controller 205 displays the specific characters CA included in the ID of the device A with widened character intervals before and after the specific characters C.

The second display section 404 displays an ID of the device B. “[Machine B ID] F33HXXYA547” for example is displayed in the second display section 404. The second determining section 202 determines the ID of the device B to be an important character string CPA. Furthermore, the first determining section 203 determines that specific characters CA are not included in the ID of the device A.

In the embodiment of the present invention as described above with reference to FIGS. 1 to 4, important character strings CPA include an e-mail address, an HP address, an ID, a PIN code, a password, a telephone number, and a fax number. Accordingly, the second determining section 202 can accurately determine whether or not there is an important character string CPA.

The display controller 205 also performs a process to display specific characters CA in bold lettering. Accordingly, the user can easily recognize erroneous input of specific characters CA.

Furthermore, the number “0” and the capital letter “0” are frequently input erroneously as each other. The number “1”, the number “7”, the lowercase letter “l”, and the capital letter “I” are frequently input erroneously as each other. The number “6” and the lowercase letter “b” are frequently input erroneously as each other. The number “9” and the lowercase letter “q” are frequently input erroneously as each other. Accordingly, the first determining section 203 can accurately determine whether or not characters C (specific characters CA) which are frequently input erroneously are included because specific alphanumeric characters include the number “0”, the capital letter “0”, the number “1”, the number “7”, the lowercase letter “l”, the capital letter “I”, the number “6”, the lowercase letter “b”, the number “8”, the capital letter “B”, the number “9”, and the lowercase letter “q”.

The display controller 205 also displays the specific characters CA with widened character intervals before and after the specific characters CA. Therefore, the specific characters CA can be displayed as easy for the user to see. Accordingly, the user can easily recognize whether or not the specific characters CA are input erroneously. Furthermore, when a specific character CA has been input erroneously, the user can easily recognize whether or not the specific character CA was properly corrected.

Note that in the embodiment of the present invention, important character strings CPA include an e-mail address, and HP address, an ID, a PIN code, a password, a telephone number, and a fax number, but the present invention is not limited as such. The important character strings CPA need only include at least one of an e-mail address, an HP address, an ID, a PIN code, a password, a telephone number, and a fax number. For example, the user may determine, from among an e-mail address, an HP address, an ID, a PIN code, a password, a telephone number, and a fax number, a character string CP that the user wishes to check for erroneous input to be an important character string CPA.

Also in the embodiment of the present invention, the display controller 205 performs a process to display specific characters CA in bold lettering, but the present invention is not limited as such. The display controller 205 need only perform at least one of a process to display the specific characters C in bold lettering, a process to assign an underline to the specific characters CA, and a process to display the specific characters CA in a specific color. For example, the specific characters CA may be displayed in a specific color (red, for example). In this case, the specific characters CA can be easily recognized even when a character string CP includes a large number (400, for example) of characters C. Accordingly, convenience for the user can be further improved.

Also according to the embodiment of the present invention, specific characters CA include the number “0”, the capital letter “O”, the number “1”, the number “7”, the lowercase letter “l”, the capital letter “I”, the number “6”, the lowercase letter “b”, the number “8”, the capital letter “B”, the number “9”, and the lowercase letter “q”, but the present invention is not limited as such. The specific characters CA need only include at least one of the number “0”, the capital letter “O”, the number “1”, the number “7”, the lowercase letter “l”, the capital letter “I”, the number “6”, the lowercase letter “b”, the number “8”, the capital letter “B”, the number “9”, and the lowercase letter “q”.

Also in the embodiment of the present invention, the display controller 205 displays specific characters CA with widened character intervals before and after the specific characters CA, but the present invention is not limited as such. The display controller 205 need only display the specific characters CA with widened character intervals at at least one of before and after the specific characters CA. Furthermore, the user may determine the degree of widening of the character intervals before and after the specific characters CA. In this case, the user can determine a character interval which facilitates viewing. Accordingly, convenience for the user can be improved.

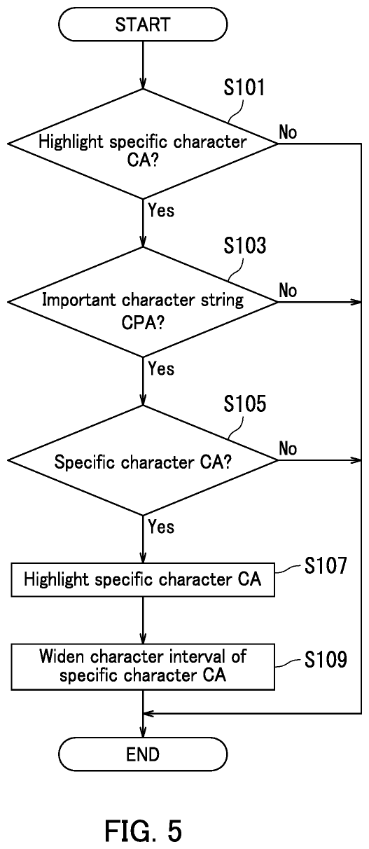

Next, the process performed by the controller 2 according to the embodiment of the present invention is further described with reference to FIGS. 1 to 5. FIG. 5 is a flowchart illustrating an example of the process performed by the controller 2.

In Step S101 as illustrated in FIG. 5, the selecting section 204 determines whether or not to highlight the specific characters CA. Specifically, when a check mark is displayed in the check input section 305 of FIG. 2, the selecting section 204 determines to highlight specific characters CA. When a check mark is not displayed in the check input section 305, the selecting section 204 determines not to highlight specific characters CA. When the selecting section 204 determines not to highlight specific characters CA (NO in Step S101), the process ends. When the selecting section 204 determines to highlight specific characters CA (YES in Step S101), the process advances to Step S103.

Then, in Step S103, when the receiving section 201 receives input of a character string CP from the touch panel 1 (corresponding to an example of “receiving”), the second determining section 202 determines whether or not the character string CP includes an important character string CPA. When the second determining section 202 determines that an important character string CPA is not included (NO in Step S103), the process ends. When the second determining section 202 determines that an important character string CPA is included (YES in Step S103), the process advances to Step S105.

Then, in Step S105, the first determining section 203 determines whether or not the important character string CPA includes a specific character CA. When the first determining section 203 determines that the important character string CPA does not include a specific character CA (NO in Step S105), the process ends. When the first determining section 203 determines that the important character string CPA does include a specific character CA (YES in Step S105), the process advances to Step S107.

Then, in Step S107, the display controller 205 highlights the specific character CA. Specifically, the display controller 205 displays the specific character CA in bold lettering.

Next, in Step S109, the display controller 205 displays the specific character CA with widened character intervals before and after the specific character CA. Thereafter, the process ends.

Step S105 corresponds to an example of “primarily determining”. Step S107 corresponds to an example of “display controlling”.

In the embodiment of the present invention as described above with reference to FIGS. 1 to 5, the selecting section 204 selects whether or not to display that a specific character CA is included. The display controller 205 then displays that a specific character CA is included according to a result of selection by the selecting section 204. Accordingly, the convenience for the user can be further improved.

Note that in the embodiment of the present invention, the selecting section 204 selects whether or not to display that a specific character CA is included according to whether or not a check mark is displayed in the check input section 305, but the present invention is not limited as such. The selecting section 204 need only select whether or not to display that a specific character CA is included. For example, when an instruction to send an e-mail is received from the user, the selecting section 204 may receive selection from the user as to whether or not to display that a specific character CA is included.

Furthermore, the embodiment of the present invention describes a case in which a symbol string is a character string CP of alphanumeric characters, but the present invention is not limited as such. The symbol string need only indicate a plurality of arranged symbols. For example, the symbol string may be a character string composed from Japanese or Chinese kanji, Japanese hiragana, and Japanese katakana. In this case, specific characters CA include for example the Japanese or Chinese kanji “ [symbol] ”, the Japanese katakana “ [symbol] ”, the Japanese katakana “ [symbol] ”, and the Japanese katakana “ [symbol] ”. The Japanese or Chinese kanji “ [symbol] ” and the Japanese katakana “ [symbol] ” are frequently input erroneously as each other. The Japanese katakana “ [symbol] ” and the Japanese katakana “ [symbol] ” are frequently input erroneously as each other.

The embodiment of the present invention is described above with reference to the accompanying drawings. However, the present invention is not limited to the above embodiment and may be implemented in various manners within a scope not departing from the gist thereof (for example, (1) and (2) illustrated below). The drawings mainly illustrate elements of configuration schematically to facilitate understanding. Aspects such as thickness, length, and number of the elements of configuration illustrated in the drawings may differ in practice for convenience of drawing preparation. Furthermore, aspects such as shape and dimension of the elements of configuration illustrated in the above embodiment are examples and not particular limitations. The elements of configuration may be variously altered within a scope not substantially departing from the configuration of the present invention.

(1) In the embodiment of the present invention as described with reference to FIG. 1, the “character input device” is the smartphone 100, but the present invention is not limited as such. The “character input device” need only include the display 11 and the controller 2. For example, the “character input device” may be a personal computer. For another example, the “character input device” may be a multifunction peripheral.

(2) In the embodiment of the present invention as described with reference to FIGS. 1 to 3, the first determining section 203 determines whether or not a character string CP includes a specific character CA, but the present invention is not limited as such. A plurality of specific characters CA may be stored in the storage 22, and the first determining section 203 may determine whether or not any of the specific characters CA stored in the storage 22 are matching.

### INDUSTRIAL APPLICABILITY

The present invention is applicable to an input control device and an input control method.

1. An input control device comprising:
a receiving section configured to receive input of a symbol string;
a first determining section configured to determine whether or not the symbol string includes a specific symbol; and
a display controller configured to display that the specific symbol is included based on a result of determination by the first determining section, wherein
the symbol string indicates a plurality of arranged symbols, and
the specific symbol indicates a symbol which is frequently input erroneously.

2. The input control device according to claim 1, wherein
the specific symbol includes at least one of a number “0”, a capital letter “O”, a number “1”, a number “7”, a lowercase letter “l”, a capital letter “I”, a number “6”, a lowercase letter “b”, a number “8”, a capital letter “B”, a number “9”, and a lowercase letter “q”.

3. The input control device according to claim 1, further comprising
a second determining section configured to determine whether or not the symbol string includes an important symbol string, wherein
the first determining section determines whether or not the important symbol string includes the specific symbol.

4. The input control device according to claim 3, wherein
the important symbol string includes at least one of an e-mail address, a home page (HP) address, an identification (ID), a personal identification number (PIN) code, a password, a telephone number, and a fax number.

5. The input control device according to claim 1, wherein
the display controller highlights the specific symbol.

6. The input control device according to claim 5, wherein
the display controller performs at least one process of a process to display the specific symbol in bold lettering, a process to attach an underline to the specific symbol, and a process to display the specific symbol in a specific color.

7. The input control device according to claim 1, further comprising
a selecting section configured to select whether or not to display that the specific symbol is included, wherein
the display controller displays that the specific symbol is included according to a result of selection by the selecting section.

8. The input control device according to claim 1, wherein
the display controller displays the specific symbol with a widened character interval at at least one of before and after the specific symbol.

9. The input control device according to claim 1, wherein
the display controller displays in a pop-up a message indicating that the specific character is included.

10. The input control device according to claim 1, further comprising:
a selecting section configured to select whether or not to display that the specific symbol is included; and
a second determining section configured to determine whether or not the symbol string includes an important symbol string, wherein
the first determining section determines whether or not the important symbol string includes the specific character when the second determining section determines that the symbol string includes the important symbol string,
the display controller displays that the specific symbol is included according to a result of selection by the selecting section when the first determining section determines that the important symbol string includes the specific symbol,
the display controller highlights the specific symbol, and
the display controller displays the specific symbol with a widened character interval at at least one of before and after the specific symbol.

11. An input control method for implementation in an input control device, the input control method comprising:
receiving input of a symbol string;
primarily determining whether or not the symbol string includes a specific symbol; and
display controlling to display that the specific symbol is included based on a result of the primarily determining, wherein
the symbol string indicates a plurality of arranged symbols, and
the specific symbol indicates a symbol which is frequently input erroneously.
